(19) United States
(12) Patent Application Publication
(10) Pub. No.: US 2025/0286924 A1
(43) Pub. Date: Sep. 11, 2025

(54) DATA PROCESSING METHOD AND SYSTEM, AI MANAGEMENT APPARATUS, AND STORAGE MEDIUM

(71) Applicant: Beijing Xiaomi Mobile Software Co., Ltd., Beijing (CN)

(72) Inventor: Dong CHEN, Beijing (CN)

(73) Assignee: Beijing Xiaomi Mobile Software Co., Ltd., Beijing (CN)

(21) Appl. No.: 18/859,762

(22) PCT Filed: Apr. 25, 2022
(86) PCT No.: PCT/CN2022/089127

§ 371 Date: Oct. 24, 2024

(51) Int. Cl. H04L 67/10

(52) U.S. Cl. CPC H04L 67/10

(57) ABSTRACT

A method, apparatus and computer-readable storage medium for data processing that improves the data transmission rate in a wireless communications. The data transmission rate is improved by an AI management apparatus determining an AI processing task, where the AI management apparatus accesses a core network and is connected to a plurality of AI service apparatuses, and the plurality of AI service apparatuses include AI service apparatuses using different AI algorithms; the AI management apparatus determining a target service apparatus from the plurality of AI service apparatuses, and allocating the AI processing task to the target service apparatus; the AI management apparatus obtaining a task processing result of the target service apparatus; and, according to the task processing result, the AI management apparatus sending to a destination end an AI service result, where the destination end includes a network element in the core network or a terminal accessing the core network.

### CROSS-REFERENCE TO RELATED APPLICATIONS

The present application is a U.S. National Stage of International Application No. PCT/CN2022/089127, filed on Apr. 25, 2022, the contents of all of which are incorporated herein by reference in their entirety for all purposes.

### BACKGROUND OF THE INVENTION

Artificial intelligence (AI) is a scientific and technological capability that simulates the human cognitive capability through machines. One factor restricting the full application of the AI technology is the lack of an appropriate carrying space.

With the development of network communication technologies, especially the development of the fifth generation mobile communication standard (5G) technology and the sixth generation mobile communication standard (6G) technology, the data transmission rate of a mobile communication network is greatly improved.

### SUMMARY OF THE INVENTION

The present disclosure provides a data processing method and system, an AI management apparatus, and a storage medium.

According to a first aspect of the embodiments of the present disclosure, a data processing method is provided, including:
determining, by an AI management apparatus, an AI processing task, where the AI management apparatus accesses a core network and is connected to a plurality of AI service apparatuses, and the plurality of AI service apparatuses include AI service apparatuses using different AI algorithms;
determining, by the AI management apparatus, a target service apparatus from the plurality of AI service apparatuses, and allocating the AI processing task to the target service apparatus;
obtaining, by the AI management apparatus, a task processing result of the target service apparatus; and
sending, by the AI management apparatus, an AI service result to a destination end according to the task processing result, where the destination end includes a network element in the core network or a terminal accessing the core network.

According to a second aspect of the embodiments of the present disclosure, an AI management apparatus is provided, including:
a processor; and
a memory configured to store executable instructions of the processor, where
the processor is configured to perform the steps of the data processing method provided in the first aspect of the embodiments of the present disclosure.

According to a third aspect of the embodiments of the present disclosure, a non-transitory computer-readable storage medium is provided, with computer program instructions stored thereon. When a processor executes the program instruction, the steps of the data processing method provided in the first aspect of embodiments of the present disclosure are implemented.

It is to be understood that the above general description and the following detailed description are merely illustrative and explanatory, and not intended to limit the present disclosure.

### BRIEF DESCRIPTION OF DRAWINGS

The above and/or additional aspects and advantages of the present disclosure will become apparent and easily understood from the description of the embodiments below in conjunction with the accompanying drawings, in which:

FIG. 1A is a schematic diagram of a network system architecture shown according to an example embodiment;

FIG. 1B is a schematic diagram of another network system architecture shown according to an example embodiment;

FIG. 2 is a schematic flowchart of a data processing method shown according to an example embodiment;

FIG. 3 is a schematic flowchart of a data processing method shown according to an example embodiment;

FIG. 4 is a schematic flowchart of a data processing method shown according to an example embodiment;

FIG. 5 is a schematic flowchart of a data processing method shown according to an example embodiment;

FIG. 6 is a schematic flowchart of a data processing method shown according to an example embodiment;

FIG. 7 is a schematic flowchart of a data processing method shown according to an example embodiment;

FIG. 8 is a schematic flowchart of a data processing method shown according to an example embodiment;

FIG. 9 is a schematic flowchart of a data processing system shown according to an example embodiment;

FIG. 10 is a schematic diagram of a network system architecture shown according to an example embodiment;

FIG. 11 is a schematic flowchart of a data processing method shown according to an example embodiment;

FIG. 12 is a structural block diagram of an AI management apparatus shown according to an example embodiment; and

FIG. 13 is a structural block diagram of an AI management apparatus shown according to an example embodiment.

### DETAILED DESCRIPTION OF THE INVENTION

Example embodiments will be described in detail herein, and examples of which are shown in the accompanying drawings. When the following description refers to the accompanying drawings, unless otherwise indicated, the same numbers in different accompanying drawings indicate the same or similar elements. The implementations described the following example embodiments do not represent all the implementations consistent with the present disclosure, and on the contrary, are simply examples of apparatuses and methods consistent with some aspects of the present disclosure, as detailed in the appended claims.

It may be understood that “a plurality of” mentioned in the present disclosure means two or more, and other quantifiers are similar. “And/or” herein describes the correspondence of the corresponding objects, indicating three kinds of relationship. For example, A and/or B can be expressed as follows: A exists alone, A and B exist concurrently, and B exists alone. The character “/” generally indicates an “or” relationship between the contextual objects. The singular forms “a/an,” “said,” and “the” are intended to include the plural forms as well, unless the context clearly indicates otherwise.

It may further be understood that although the terms “first,” “second,” etc., are used to describe various information, but the information is not to be limited to these terms. These terms are merely used to distinguish information of the same type from each other, and do not indicate a specific order or importance. In fact, the expressions such as “first” and “second” may be used interchangeably. For example, “first information frame” may also be referred to as “second information frame” without departing from the scope of the present disclosure. Similarly, “second information frame” may also be referred to as “first information frame”.

It may further be understood that, although operations are depicted in the accompanying drawings in a particular order, it is not to be construed that such operations need to be performed in the particular order shown, or in a sequential order, or all illustrated operations need to be performed to achieve desirable results. In certain circumstances, multitasking and parallel processing may be advantageous.

In addition, all actions to acquire signals, information or data in the present application are carried out in accordance with the appropriate data protection regulations and policies of the country where they are located and with the authorization of the owners of the respective apparatuses.

The development trend of future communication technologies is to use a communication network as a carrier space for AI technology. At present, the 3rd generation partnership project (3GPP) introduces a network data analytics function (NWDAF). NWDAF is a network data analysis function in a 5G network defined by 3GPP SA2, which may collect data from various network functions (NFs), application functions (AFs), and operation administration and maintenance (OAM) systems for analysis and prediction. However, the types of data analysis provided by NWDAF are not subdivided in the related art. Even if there is a plurality of NWDAF instances in the network, no technical specifications for appropriate NWDAF are found in the related art for consumers of network data analysis services, given less consideration to how to integrate the AI technology into a communication network.

In order to solve the above problems, the disclosure relates to the field of data processing, and the embodiments of the present disclosure provide a data processing method and system, an AI management apparatus, and a storage medium. The following first describes implementation environments of the embodiments of the present disclosure.

The embodiments of the present disclosure may be applicable to a 4th generation mobile communication (4G) evolution system, such as a long term evolution (LTE) system; or a 5th generation mobile communication (5G) system, such as an access network using a new radio access technology (New RAT); or a cloud radio access network (CRAN) or other communication systems.

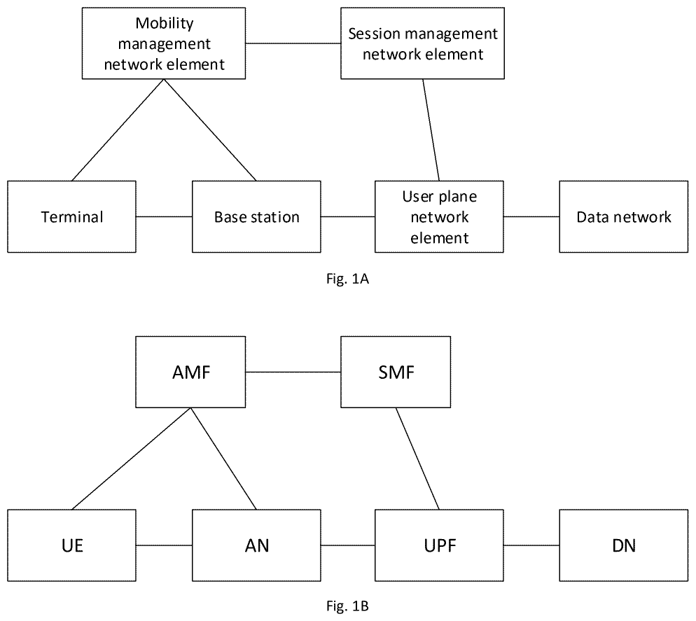

FIG. 1A schematically shows a schematic diagram of a system architecture applicable to an embodiment of the present disclosure. It is to be understood that the embodiments of the present disclosure are not limited to the system shown in FIG. 1A. In addition, the apparatus in FIG. 1A may be hardware, functionally divided software, or a structure of a combination thereof. As shown in FIG. 1A, the system architecture provided in an embodiment of the present disclosure includes a terminal, a base station, a mobility management apparatus, a session management apparatus, a user plane network element, and a data network (DN). The terminal communicates with the DN through the base station and the user plane network element.

The network element shown in FIG. 1A may be either a network element in a 4G architecture or a network element in a 5G architecture.

The data network (DN), which provides users with a data transmission service, may be a protocol data unit (PDN) network, such as the Internet or an IP multi-media service (IMS).

Referring to the schematic diagram of a 5G system architecture shown in FIG. 1B, the mobility management apparatus may include an access and mobility management function (AMF) in 5G. The mobility management apparatus is responsible for the access and mobility management of a terminal in a mobile network. The AMF is responsible for terminal access and mobility management, NAS message routing, session management function (SMF) selection, etc. The AMF may be used as an intermediate network element for transmitting a session management message between the terminal and SMF.

The session management apparatus is responsible for forwarding path management, e.g., issuing a message forwarding policy to the user plane network element and instructing the user plane network element to perform message processing and forwarding according to the message forwarding policy. The session management apparatus may be the SMF in 5G (as shown in FIG. 1B) and is responsible for session management, such as session creation/modification/deletion, user plane network element selection, user plane tunnel information allocation and management, etc.

The user plane network element may be a user plane function (UPF) entity in the 5G architecture, as shown in FIG. 1B. The UPF is responsible for message processing and forwarding.

The system architecture provided in an embodiment of the present disclosure may also include a data management apparatus for processing terminal device identifier, access authentication, registration, mobility management, etc. In a 5G communication system, the data management apparatus may be a unified data management (UDM) network element.

The system architecture provided in an embodiment of the present disclosure may also include a policy control function (PCF) or a policy and charging control function (PCRF) entity. The PCF or PCRF entity is responsible for policy control decisions and stream-based charging controls.

The system architecture provided in an embodiment may also include a network storage network element for maintaining real-time information of all network function services in the network. In the 5G communication system, the network storage network element may be a network repository function (NRF) network element. Information on many network elements, such as SMF information, UPF information, and AMF information, may be stored in the NRF network element. AMF, SMF, UPF and other network elements in the network may be connected to the NRF network element and may register their own network element information to the NRF network element on the one hand, and other network elements may obtain information of registered network elements from the NRF network element on the other hand. Other network elements (e.g., the AMF network element) may request optional network elements based on network element types, data network identifiers, unknown area information, etc., from the NRF network element. If a domain name system (DNS) server is integrated into the NRF network element, a corresponding network element (e.g., the AMF network element) with a selected function may request other network elements (e.g., the SMF network element) to be selected from the NRF network element.

As a specific implementation of an access network (AN), the base station may also be known as an access node, or as a radio access network (RAN) in the case of a radio access form, as shown in FIG. 1B, to provide a radio access service for the terminal. The access node may specifically be a base station in a global system for mobile communication (GSM) system or a code division multiple access (CDMA) system, or a base station (NodeB) in a wideband code division multiple access (WCDMA) system, or an evolutional node B (eNB or eNodeB) in an LTE system, or a base station device, a small base station device, a wireless access node (WiFiAP), and a worldwide interoperability for microwave access base station (WiMAX BS) in the 5G network, etc., which will not be limited in the present disclosure.

The terminal may also be referred to as an access terminal, a user equipment (UE), a user unit, a user station, a mobile station, a mobile platform, a remote station, a remote terminal, a mobile device, a user terminal, a wireless communication device, a user agent, or a user apparatus, etc. FIG. 1B is described by taking the UE as an example. The terminal may be a cellular phone, a cordless phone, a session initiation protocol (SIP) phone, a wireless local loop (WLL) station, a personal digital assistant (PDA), a handheld device having a wireless communication function, a computing device, or other processing device, vehicle-mounted device, wearable device or Internet of Things terminal device (e.g., a fire detection sensor, a smart water/electricity meter, or a factory monitoring device) connected to a wireless modem.

The above functions may be network elements in a hardware device, or software functions running on specialized hardware, or virtualization functions instantiated on a platform (e.g., a cloud platform).

FIG. 2 is a flowchart of a data processing method shown according to an example embodiment. As shown in FIG. 2, the data processing method includes the following steps. In S201, an AI management apparatus determines an AI processing task.

The AI management apparatus accesses a core network and is connected to a plurality of AI service apparatuses, and the plurality of AI service apparatuses includes AI service apparatuses using different AI algorithms.

Data processing method provided in an embodiment of the present disclosure may be performed by an AI management apparatus. In future communications and AI technologies, the executive body, such as the AI management apparatus, may have other names, which will not be limited in the present application. The AI management apparatus is connected to the plurality of AI service apparatuses. The plurality of AI service apparatuses include AI service apparatuses using different AI algorithms. The AI management apparatus accesses the core network. It is to be understood that the communication network includes an access network (the base station shown in FIG. 1A), a bearer network, and a core network (the mobility management apparatus or the session management apparatus shown in FIG. 1A, or the NRF shown in FIG. 1B). In addition, it is to be understood that the AI management apparatus may be a separate apparatus, each AI service apparatus may be a separate apparatus, and some or all of the AI service apparatuses may be integrated in the same apparatus. Alternatively, some or all of the AI service apparatuses may also be integrated in the same apparatus together with the AI management apparatus, in which case the connection between the AI management apparatus and the AI service apparatuses is to be understood as a logical connection on a software layer.

In S202, the AI management apparatus determines a target service apparatus from the plurality of AI service apparatuses, and allocates the AI processing task to the target service apparatus. At least one of the plurality of AI service apparatuses is determined as the target service apparatus.

In S203, the AI management apparatus obtains a task processing result of the target service apparatus.

In S204, the AI management apparatus sends an AI service result to a destination end according to the task processing result. The destination end includes a network element in the core network or a terminal accessing the core network.

By using the above method, the plurality of AI service apparatuses include the AI service apparatuses using different AI algorithms, that is, each AI service apparatus corresponds to a class of AI algorithms, and the AI management apparatus manages the plurality of AI service apparatuses in a unified manner. In this way, after accessing the core network, the AI management apparatus can schedule the plurality of AI service apparatuses in a unified manner to provide an AI service for the network element in the core network or the terminal accessing the core network, so that the AI service can be used within a network coverage provided by the core network, thereby expanding an application space of the AI service.

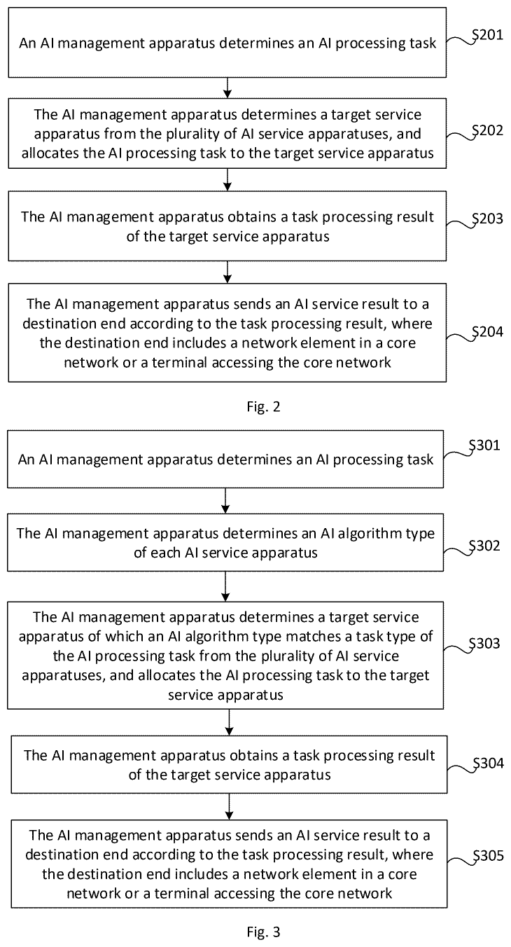

FIG. 3 is a flowchart of a data processing method shown according to an example embodiment. As shown in FIG. 3, the data processing method includes the following steps. In S301, an AI management apparatus determines an AI processing task.

The AI management apparatus accesses a core network and is connected to a plurality of AI service apparatuses, and the plurality of AI service apparatuses include AI service apparatuses using different AI algorithms.

In S302, the AI management apparatus determines an AI algorithm type of each AI service apparatus.

The AI algorithm type of each AI service apparatus may be pre-stored in the AI management apparatus. Alternatively, the AI management apparatus may store the AI algorithm type of each AI service apparatus in the NRF network element in the core network while accessing the core network, so that the AI algorithm type of each AI service apparatus may be determined by querying for the NRF network element.

In S303, the AI management apparatus determines a target service apparatus of which an AI algorithm type matches a task type of the AI processing task from the plurality of AI service apparatuses, and allocates the AI processing task to the target service apparatus.

In one example, a matching relationship between the AI algorithm type and the task type of the AI processing task may be preset.

For example, the AI processing task may include model training. The task types of the model training may be divided based on a model training method, e.g., divided into supervised training, unsupervised training, semi-supervised training, etc. The AI algorithm types include a random forest algorithm, a support vector machine algorithm, a principal component analysis dimensionality reduction algorithm, a K-means clustering algorithm, etc. According to the characteristics of different AI algorithms, an appropriate training method for each AI algorithm may be determined, so that the matching relationship between the AI algorithm type and the task type may be preset.

The above is merely an example, and the task types of the model training may also be divided based on model training stages. For example, the task types may be divided into data labeling, iterative training, model validation, etc. The task types of the AI processing task may also be the types of subtasks in a federated learning task, or the types of subtasks in an edge computing task.

In S304, the AI management apparatus obtains a task processing result of the target service apparatus.

In S305, the AI management apparatus sends an AI service result to a destination end according to the task processing result. The destination end includes a network element in the core network or a terminal accessing the core network.

According to the present embodiment, by matching the AI algorithm type and the task type, the AI management apparatus can accurately allocate, for the AI processing task, the target service apparatus for executing the AI processing task.

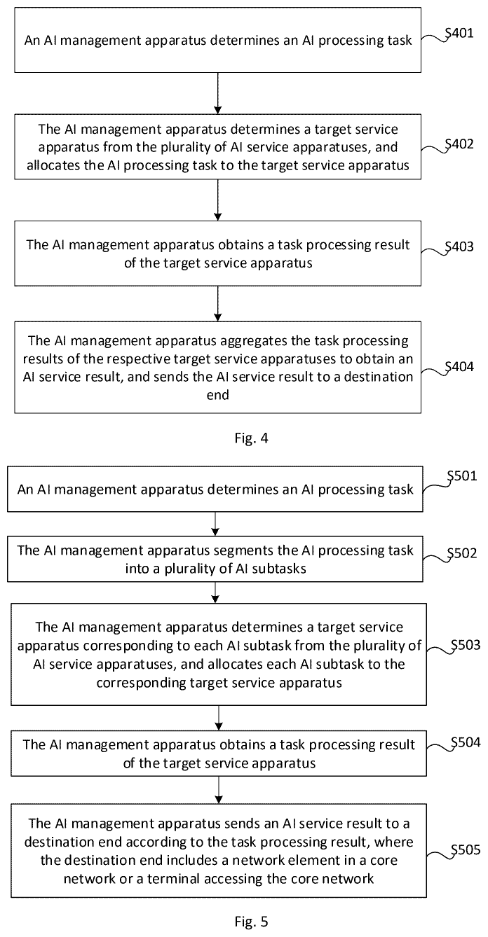

FIG. 4 is a flowchart of a data processing method shown according to an example embodiment. As shown in FIG. 4, the data processing method includes the following steps. In S401, an AI management apparatus determines an AI processing task.

The AI management apparatus accesses a core network and is connected to a plurality of AI service apparatuses, and the plurality of AI service apparatuses include AI service apparatuses using different AI algorithms.

In S402, the AI management apparatus determines a target service apparatus from the plurality of AI service apparatuses, and allocates the AI processing task to the target service apparatus.

In this embodiment, the number of target service apparatuses is multiple.

In S403, the AI management apparatus obtains task processing results of the target service apparatuses.

In S404, the AI management apparatus aggregates the task processing results of the respective target service apparatuses to obtain an AI service result, and sends the AI service result to a destination end.

The destination end includes a network element in the core network or a terminal accessing the core network.

In one example, aggregating, by the AI management apparatus, the processing task results may include structuring the processing task results, so that the obtained AI service result conforms to a data format specification of the core network.

In another example, aggregating, by the AI management apparatus, the processing task results may include selecting an optimal task processing result from the plurality of task processing results as the AI service result. For example, the same AI processing task may be allocated to the target service apparatuses of different AI algorithm types, and after receiving the task processing results returned by the target service apparatuses of different AI algorithm types, a task processing result with the optimal effect may be selected as the AI service result. The same AI processing task may be, for example, an image processing task, a speech recognition task, a machine translation task, etc. Alternatively, by aggregating the processing task results by the AI management apparatus, the processing task results may include obtaining an AI service result by calculating and analyzing the plurality of task processing results. For example, edge computing performs model training tasks. Each target service apparatus may be used as an edge computing node to perform part of the subtasks in the model training task. In this way, after receiving the task processing result returned by each target service apparatus, the AI management apparatus may obtain a finally trained mathematical model by aggregating the plurality of task processing results. The AI service results include the finally trained mathematical model.

According to the present embodiment, since the AI management apparatus can aggregate the task processing results of the plurality of AI service apparatuses, the granularity of dividing the AI service apparatuses according to the AI algorithm may be finer (that is, the AI algorithm used to complete a certain type of AI tasks can be split into a plurality of sub-algorithms at a finer granularity), thereby avoiding the problems of the excessive number of target service apparatuses used to complete the same AI processing task and the failure of unified management of the task processing results due to the excessive division of the AI service apparatuses.

FIG. 5 is a flowchart of a data processing method shown according to an example embodiment. As shown in FIG. 5, the data processing method includes the following steps. In S501, an AI management apparatus determines an AI processing task.

The AI management apparatus accesses a core network and is connected to a plurality of AI service apparatuses, and the plurality of AI service apparatuses include AI service apparatuses using different AI algorithms.

In S502, the AI management apparatus segments the AI processing task into a plurality of AI subtasks.

In S503, the AI management apparatus determines a target service apparatus corresponding to each respective AI subtask from the plurality of AI service apparatuses, and allocates the respective AI subtask to the corresponding target service apparatus.

In S504, the AI management apparatus obtains a task processing result of the target service apparatus.

In S505, the AI management apparatus sends an AI service result to a destination end according to the task processing result.

The destination end includes a network element in the core network or a terminal accessing the core network.

The AI processing task may be a total task corresponding to service requirements. The AI processing task is segmented into a plurality of subtasks, and different subtasks may be allocated to and completed by different target service apparatuses, thereby improving the efficiency of obtaining the final AI service result for responding to the service requirements. In addition, for a scenario in which the use of private data is required to execute the AI processing task, the AI processing task is segmented into a plurality of subtasks (e.g., those involved in model training using federated learning or edge computing), and different subtasks are executed respectively by using different AI service apparatuses, thereby effectively avoiding data leakage and improving data security. It is worth noting that the AI processing task may include data to be processed, so that the target service apparatus can perform task processing on the data to be processed after the AI management apparatus allocates the AI processing task to the target service apparatus. Alternatively, the AI processing task may include storage location information of the data to be processed, so that after the AI management apparatus allocates the AI processing task to the target service apparatus, the target service apparatus can obtain the data to be processed according to the storage location information, and perform task processing on the data to be processed.

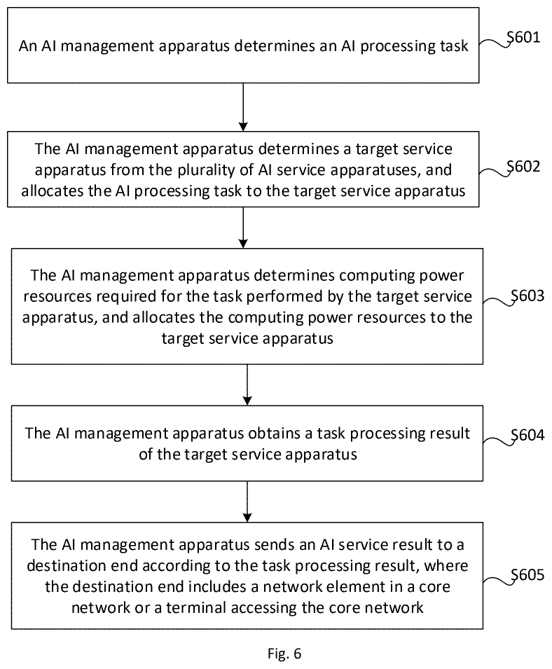

FIG. 6 is a flowchart of a data processing method shown according to an example embodiment. As shown in FIG. 6, the data processing method includes the following steps. In S601, an AI management apparatus determines an AI processing task.

The AI management apparatus accesses a core network and is connected to a plurality of AI service apparatuses, and the plurality of AI service apparatuses include AI service apparatuses using different AI algorithms.

In S602, the AI management apparatus determines a target service apparatus from the plurality of AI service apparatuses, and allocates the AI processing task to the target service apparatus.

At least one of the plurality of AI service apparatuses is determined as the target service apparatus.

In S603, the AI management apparatus determines computing power resources required for a task performed by the target service apparatus, and allocates the computing power resources to the target service apparatus.

In S604, the AI management apparatus obtains a task processing result of the target service apparatus.

In S605, the AI management apparatus sends an AI service result to a destination end according to the task processing result. The destination end includes a network element in the core network or a terminal accessing the core network.

According to the present embodiment, the AI management apparatus is responsible for allocating computing power resources for the AI service apparatuses, and capable of balancing the computing power resources of each target service apparatus in the presence of a plurality of target service apparatuses. In addition, in the case that the same AI processing task has been completed by task processing jointly performed by the plurality of target service apparatuses, the efficiency of the respective target service apparatuses to jointly complete the task processing can be improved by controlling the size of the computing power resources allocated to the respective target service apparatuses.

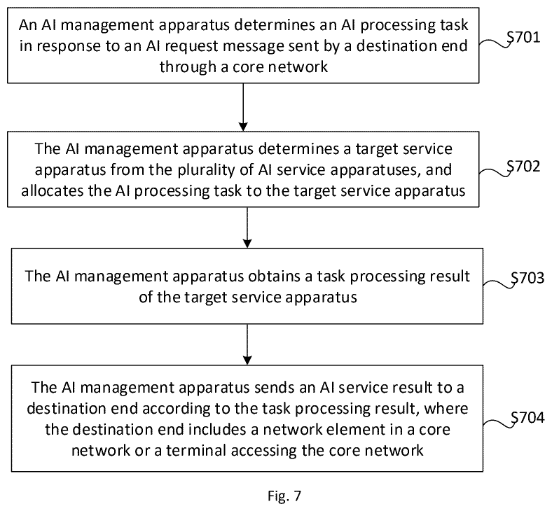

FIG. 7 is a flowchart of a data processing method shown according to an example embodiment. As shown in FIG. 7, the data processing method includes the following steps.

In S701, an AI management apparatus determines an AI processing task in response to an AI request message sent by a destination end through a core network.

The AI management apparatus accesses the core network and is connected to a plurality of AI service apparatuses, and the plurality of AI service apparatuses include AI service apparatuses using different AI algorithms. The destination end is a terminal (also known as an access terminal or UE) accessing the core network. The terminal may access the core network through an access network (AN) or through a radio access network (RAN).

In one example, the request message sent by the terminal may include identifier information to indicate an AI processing task, and the AI management apparatuses may determine the AI processing task based on the identifier information after receiving the request message.

In one example, the request message sent by the terminal may include data to be processed, and the AI management apparatus determines the AI processing task based on attributes of the data to be processed after receiving the request message. For example, the attributes of the data to be processed may be a type of the data, a structure of the data, etc. For example, in the case that the type of the data to be processed is a text type, the AI processing task determined by the AI management apparatus may be text recognition and/or machine translation; and in the case that the type of the data to be processed is an image type, the AI processing task determined by the AI management apparatus may be image recognition.

In S702, the AI management apparatus determines a target service apparatus from the plurality of AI service apparatuses, and allocates the AI processing task to the target service apparatus. At least one of the plurality of AI service apparatuses is determined as the target service apparatus.

In one example, the request message sent by the terminal may include data to be processed. After receiving the request message, the AI management apparatus may store the data to be processed in a user data repository (UDR) or unstructured data storage network function (UDSF) in the core network. In this case, the AI processing task may include storage location information of the data to be processed in the UDR or UDSF, so that the target service apparatus may obtain the data to be processed for task processing from the UDR or UDSF based on the storage location information after receiving the AI processing task. In another example, the terminal may also store the data to be processed in the UDR or UDSF in the course of accessing the core network for registration, so that the request message sent to the AI management apparatus may include the storage location information of the data to be processed after the terminal completes the process of accessing the core network.

In S703, the AI management apparatus obtains a task processing result of the target service apparatus.

In S704, the AI management apparatus sends an AI service result to a destination end according to the task processing result. The destination end includes a network element in the core network or a terminal accessing the core network.

In one example, according to the task processing result, the AI management apparatus transparently transmits the AI processing result to the destination end via the core network, thereby improving the efficiency of data transmission. For example, the AI management apparatus may send the AI processing result to a mobility management apparatus (e.g., the AMF in 5G), and the AMF may transparently transmit the AI service result to the terminal through the base station or the radio access network.

According to the present embodiment, the plurality of AI service apparatuses include the AI service apparatuses using different AI algorithms, and the AI management apparatus manages the plurality of AI service apparatuses in a unified manner. In this way, after accessing the core network, the AI management apparatus can schedule the plurality of AI service apparatuses in a unified manner to provide an AI service for the terminal accessing the core network, so that the AI service can be used within a network coverage provided by the core network, thereby expanding an application space of the AI service.

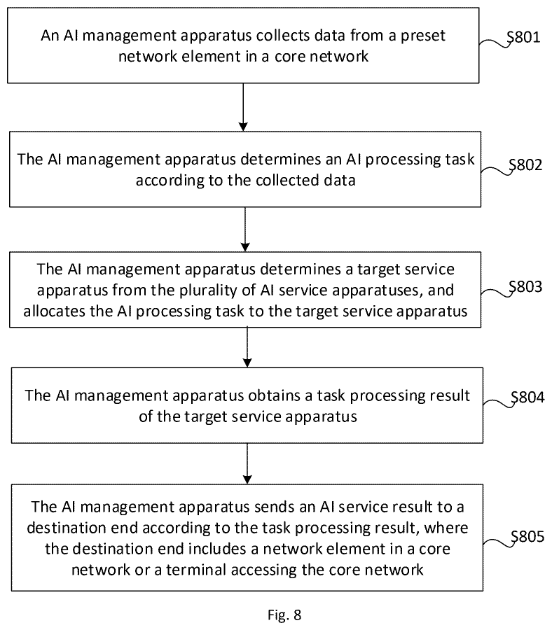

FIG. 8 is a flowchart of a data processing method shown according to an example embodiment. As shown in FIG. 8, the data processing method includes the following steps.

In S801, an AI management apparatus collects data from a preset network element in a core network.

The AI management apparatus accesses a core network and is connected to a plurality of AI service apparatuses, and the plurality of AI service apparatuses include AI service apparatuses using different AI algorithms.

In one example, the AI management apparatus may collect data from various network functions (such as AMF, SMF, policy control function, and network capability exposure function), application functions, and operation management and maintenance systems in the core network.

In S802, the AI management apparatus determines an AI processing task according to the collected data.

The AI processing task may be a pre-customized AI processing task for the preset network element in the core network, such as a pre-customized fault diagnosis task, a service optimization task, etc., for a preset network element. The AI processing task may include data collected from the preset network element.

In S803, the AI management apparatus determines a target service apparatus from the plurality of AI service apparatuses, and allocates the AI processing task to the target service apparatus. At least one of the plurality of AI service apparatuses is determined as the target service apparatus.

In S804, the AI management apparatus obtains a task processing result of the target service apparatus.

In S805, the AI management apparatus sends an AI service result to a destination end according to the task processing result. The destination end includes a network element in the core network.

In one example, based on the task processing result, the AI management apparatus determines a target network element, which requires service adjustment, in the core network, and sends the AI service result to the target network element in the core network as the destination end.

By using the above method, the plurality of AI service apparatuses include AI service apparatuses using different AI algorithms, and the AI management apparatus manages the plurality of AI service apparatuses in a unified manner. In this way, after accessing the core network, the AI management apparatus may schedule the plurality of AI service apparatuses in a unified manner to provide an AI service for the network element in the core network, and to provide support for the network element in the core network in terms of fault recovery, service optimization, etc., thereby improving the autonomy level of the core network.

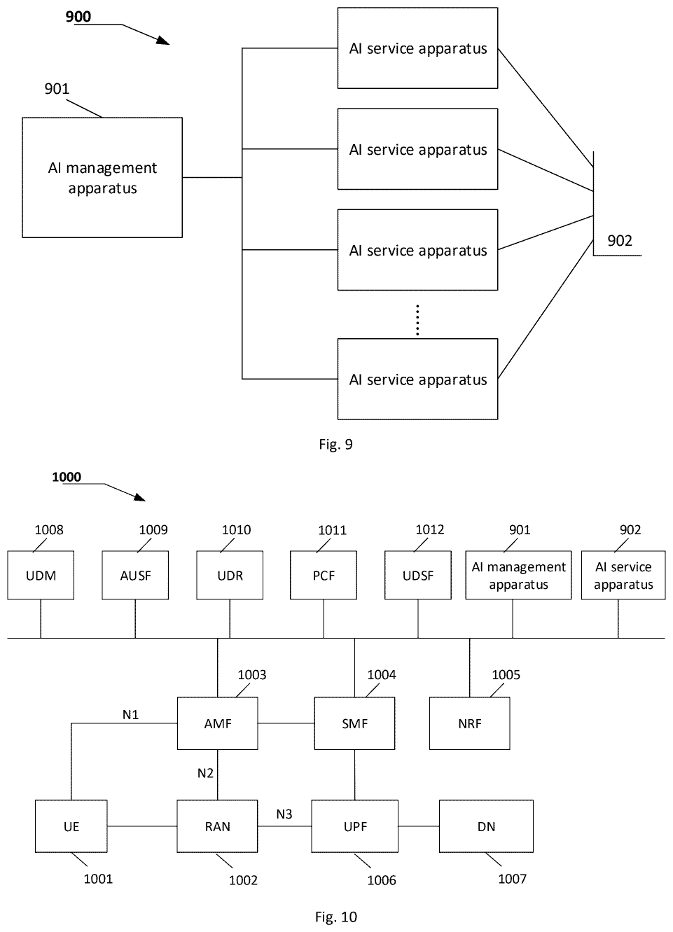

FIG. 9 is a schematic diagram of a data processing system shown according to an example embodiment. The data processing system 900 includes an AI management apparatus 901 and a plurality of AI service apparatuses 902 all connected to the AI management apparatus 901. The plurality of AI service apparatuses 902 include AI service apparatuses 902 using different AI algorithms. The AI management apparatus 901 is configured to access the core network and perform the data processing method provided in any of the above method embodiments. The AI service apparatuses 902 are configured to, in response to receiving an AI processing task allocated by the AI management apparatus 901, obtain data to be processed corresponding to the AI processing task for AI task processing.

FIG. 10 is a schematic diagram of a network system shown according to an example embodiment, which is used for showing implementation environments of the data processing system 900 shown in FIG. 9. The network system 1000 shown in FIG. 10 includes UE 1001, RAN 1002, AMF 1003, SMF 1004, NRF 1005, UPF 1006, DN 1007, UDM 1008, AUSF 1009, UDR 1010, PCF 1011, UDSF 1012, an AI management apparatus 901, and AI service apparatuses 902. The RAN 1002 is connected to the AMF 1003 via an N2 interface, the RAN 1002 is connected to the UPF 1006 via an N3 interface, and the UE 1001 is connected to the AMF 1003 via an N1 interface.

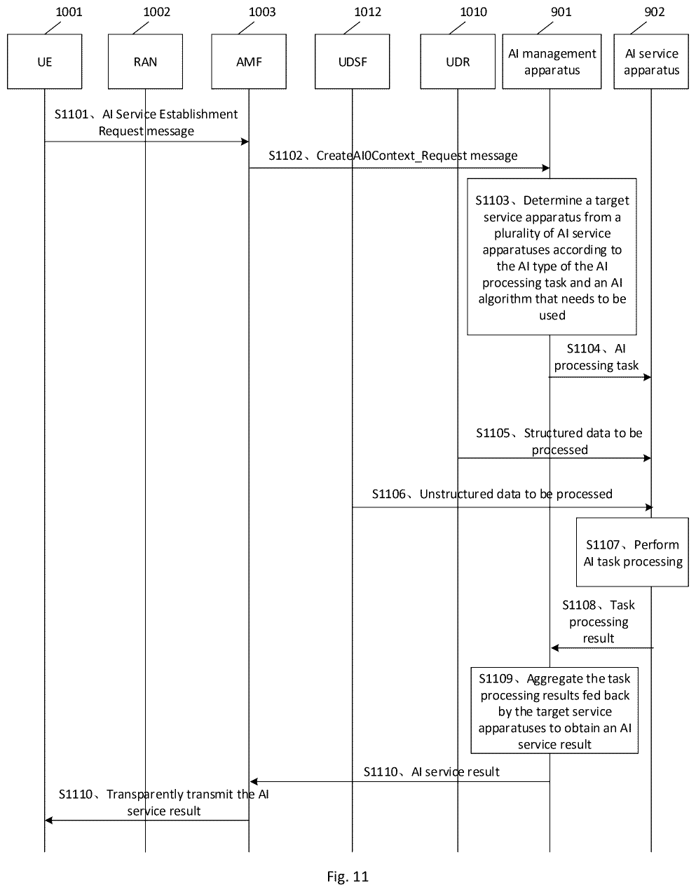

FIG. 11 is a schematic diagram of a data processing method shown according to an example embodiment, which is used to illustrate the method steps of the data processing system 900 shown in FIG. 9 in the network system 1000 shown in FIG. 10. As shown in FIG. 11, the method steps include the following steps.

In S1101, a UE 1001 sends an AI Service Establishment Request message to an AMF 1003 via a RAN 1002.

The AI Service Establishment Request message may include a data network name (DNN), an AI service type, an AI service ID, etc. The AI service type is used to indicate a type of an AI processing task.

In S1102, the AMF 1003 sends a CreateAIOContext_Request message to an AI management apparatus 901 to request provision of an AI service.

The CreateAIOContext_Request message may include: DNN, AI service type, AI service ID, user information, access type, permanent equipment identifier (PEI), generic public subscription identifier (GPSI), and other information.

In S1103, the AI management apparatus 901 determines an AI processing task based on the received request message, and determines a target service apparatus from a plurality of AI service apparatuses 902 according to the AI type of the AI processing task and an AI algorithm that needs to be used.

For example, the AI type of AI processing task may include a supervised, an unsupervised and a semi-supervised type, and the AI algorithm that needs to be used in the AI processing task may include SVM, random forest, PCA dimensionality reduction and K-means clustering algorithms, etc.

In S1104, the AI management apparatus 901 issues the AI processing task to the target service apparatus, and allocates computing power resources to the target service apparatus.

When there are a plurality of target service apparatuses, the AI management apparatus 901 may set a corresponding weight for each target service apparatus according to a task corresponding to each respective target service apparatus, and determines the size of the computing power resources allocated to each respective target service apparatus according to the weight.

In S1105, a UDR 1010 provides structured data to be processed to the target service apparatuses.

In S1106, a UDSF 1012 provides unstructured data to be processed to the target service apparatuses.

A data source for both the structured data to be processed and unstructured data to be processed may be stored in the UDR 1010 and the UDSF 1012 when the UE 1001 accesses the core network and/or makes a service request.

In S1107, the target service apparatuses perform AI task processing.

In S1108, the target service apparatuses feed task processing results back to the AI management apparatus 901.

In S1109, the AI management apparatus 901 aggregates the task processing results fed back by the target service apparatuses to obtain an AI service result.

In S1110, the AI management apparatus 901 transmits the AI service result to the AMF 1003.

In S1110, the AMF 1003 transparently transmits the AI service result to the UE 1001 via the RAN 1002.

For the sake of simple description, the above method embodiments are described as a series of combined actions. However, it is to be understood by those skilled in the art that the present disclosure is not limited by described sequences of the actions. Secondly, it is also to be understood by those skilled in the art that the embodiments described above belong to preferred embodiments, and those steps involved are not necessarily essential to the present disclosure.

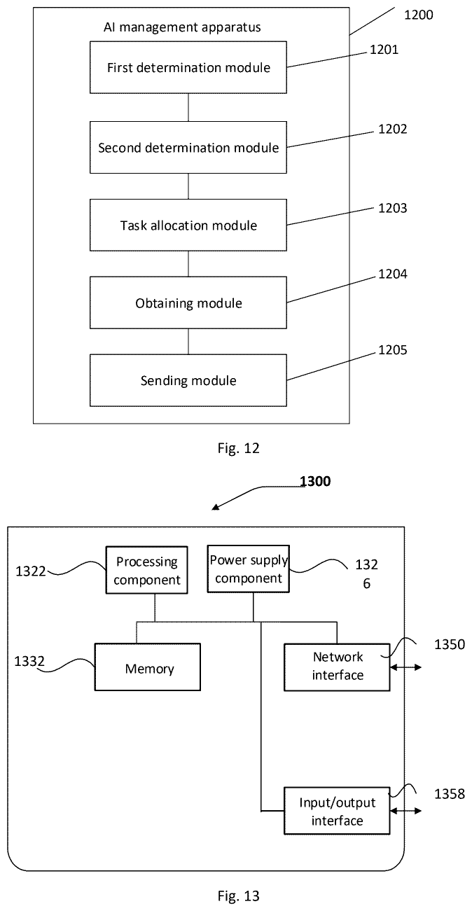

FIG. 12 is a structural block diagram of an AI management apparatus shown according to an example embodiment. The AI management apparatus 1200 accesses a core network and is connected to a plurality of AI service apparatuses, and the plurality of AI service apparatuses include AI service apparatuses using different AI algorithms. The AI management apparatus 1200 may be implemented through software, hardware, or a combination of software and hardware to perform the steps of the data processing method described above. Referring to FIG. 12, the AI management apparatus 1200 includes a first determination module 1201, a second determination module 1202, a task allocation module 1203, an obtaining module 1204, and a sending module 1205.

The first determination module 1201 is configured to determine an AI processing task.

The second determination module is configured to determine a target service apparatus from the plurality of AI service apparatuses.

The task allocation module 1203 is configured to allocate the AI processing task to the target service apparatus.

The obtaining module 1204 is configured to obtain a task processing result of the target service apparatus.

The sending module 1205 is configured to send an AI service result to a destination end according to the task processing result. The destination end includes a network element in the core network or a terminal accessing the core network.

In the technical solutions provided in the embodiments of the present disclosure, the plurality of AI service apparatuses include AI service apparatuses using different AI algorithms, and the AI management apparatus manages the plurality of AI service apparatuses in a unified manner. In this way, after accessing the core network, the AI management apparatus can schedule the plurality of AI service apparatuses in a unified manner to provide an AI service for the network element in the core network or the terminal accessing the core network, so that the AI service can be used within a network coverage provided by the core network, thereby expanding an application space of the AI service.

Optionally, the first determination module 1201 includes:
a first determination submodule, configured to determine an AI algorithm type of each AI service apparatus; and
a second determination submodule, configured to determine a target service apparatus of which an AI algorithm type matches a task type of the AI processing task from the plurality of AI service apparatuses.

Optionally, the number of target service apparatuses is multiple. The sending module 1105 includes:
an aggregation submodule, configured to aggregate the task processing results of the respective target service apparatuses to obtain the AI service result; and
a sending submodule, configured to send the AI service result to the destination end. Optionally, the task allocation module 1203 includes:

a task segmentation submodule, configured to segment the AI processing task into a plurality of AI subtasks; and
an allocation submodule, configured to determine a target service apparatus corresponding to each respective AI subtask from the plurality of AI service apparatuses, and allocate the respective AI subtask to the corresponding target service apparatus.

Optionally, the AI management apparatus 1200 also includes:
a third determination module, configured to determine computing power resources required for the task performed by the target service apparatus; and
a computing power allocation module, configured to allocate the computing power resources to the target service apparatus.

Optionally, the AI processing task includes data to be processed or storage location information of the data to be processed. The data to be processed is used for the target service apparatus to perform the AI processing task.

Optionally, the destination end is a terminal accessing the core network, and the first determining module 1201 is specifically configured to determine the AI processing task in response to an AI request message sent by the destination end via the core network.

Optionally, the AI request message includes data to be processed. The AI management apparatus 1200 also includes a storage module configured to store the data to be processed in a UDR or UDSF in the core network. The AI processing task includes the storage location information of the data to be processed.

Optionally, the sending module 1205 is specifically used for the AI management apparatus 1200 to, according to the task processing result, transparently transmit the AI processing result to the destination end via the core network.

Optionally, the destination end is a network element in the core network. The first determination module 1201 includes: a data collection submodule, configured to collect data of a preset network element in the core network; and a third determining submodule, configured to determine the AI processing task according to the collected data.

Optionally, the destination end is a network element in the core network. The sending module 1205 includes:
a fourth determining submodule, configured to determine a target network element, which requires service adjustment, in the core network according to the task processing result; and
a sending submodule, configured to send the AI service result to the target network element serving as the destination end.

With respect to the apparatus in the foregoing embodiments, the specific manner in which each module performs the operation has been described in detail in the embodiments of the method, and a detailed description will not be given here.

The present disclosure also provides a computer-readable storage medium, having a computer program instruction stored thereon, where the program instruction, when executed by a processor, causes the processor to implement the steps of the data processing method provided by any of the forgoing embodiments provided in the present disclosure.

FIG. 13 is a structural block diagram of an AI management apparatus shown according to an example embodiment. For example, the AI management apparatus 1300 may be provided as a server. Referring to FIG. 13, the AI management apparatus 1300 includes a processing component 1322 which further includes one or more processors, and memory resources represented by a memory 1332 for storing instructions executable by the processing component 1322, such as applications. The applications stored in the memory 1332 may include one or more modules, each corresponding to a set of instructions. In addition, the processing component 1322 is configured to execute instructions to perform the steps of the data processing methods provided in the above method embodiments.

The AI management apparatus 1300 may also include a power supply component 1326 configured to perform power management of the AI management apparatus 1300, one or more wired or wireless network interfaces 1350 configured to connect the AI management apparatus 1300 to a network, and one or more input/output (I/O) interfaces 1358. The AI management apparatus 1300 may operate based on an operating system stored in the memory 1332, such as Windows Server™, Mac OS X™, Unix™, Linux™, FreeBSD™ or analogs.

In another example, a computer program product is also provided. The computer program product includes a computer program capable of being executed by a programmable apparatus. The computer program has a code portion for executing the data processing method described above when executed by the programmable apparatus.

Other embodiments of the present disclosure will be readily conceivable to those skilled in the art from consideration of the specification and practicing the present disclosure herein. This disclosure is intended to cover any variations, uses, or adaptations of the present disclosure, which follow the general principles of the present disclosure and include common knowledge or customary technical means in the technical field not disclosed in the present disclosure. The specification and embodiments are to be considered merely exemplary, and the true scope and spirit of the present disclosure are indicated by the following claims.

It is to be understood that the present disclosure is not limited to the exact construction that has been described above and illustrated in the accompanying drawings, and that various modifications and changes may be made without departing from the scope thereof. The scope of the present disclosure is merely limited by the appended claims.

1. A method for data processing, comprising:
determining an artificial intelligence (AI) processing task via a core network;
determining a target service apparatus from a plurality of AI service apparatuses, wherein each of the plurality of the AI service apparatuses, utilize a different AI algorithm;
allocating the AI processing task to the target service apparatus;
obtaining a task processing result of the target service apparatus; and
sending an AI service result to a destination end according to the task processing result, wherein the destination end comprising a network element in the core network or a terminal accessing the core network.

2. The method according to claim 1, wherein the determining a target service apparatus from a plurality of AI service apparatuses comprises:
determining an AI algorithm type of at least one AI service apparatus; and
determining a respective target service apparatus of which a respective AI algorithm type matches a task type of the AI processing task from the plurality of AI service apparatuses.

3. The method according to claim 1, wherein when a multiple number of the target service apparatus are determined, the method further includes:
the sending comprises:
aggregating the task processing results of each of respective target service apparatuses to obtain the AI service result, and sending the AI service result to the destination end.

4. The method according to claim 1, wherein the determining a target service apparatus from a plurality of AI service apparatuses comprises:
segmenting the AI processing task into a plurality of AI subtasks; and
determining a respective target service apparatus corresponding to at least one AI subtask from the plurality of AI service apparatuses, and allocating the at least one AI subtask to the corresponding target service apparatus.

5. The method according to claim 1, further comprising:
determining computing power resources required for the AI processing task performed by the target service apparatus, and
allocating the computing power resources to the target service apparatus.

6. The method according to claim 1, wherein the AI processing task comprises data to be processed or storage location information of the data to be processed, and the data to be processed is used for the target service apparatus to perform the AI processing task.

7. The method according to claim 1, wherein:
the destination end is the terminal accessing the core network; and
the determining an artificial intelligence (AI) processing task comprises:
determining the AI processing task in response to an AI request message sent by the destination end via the core network.

8. The method according to claim 7, wherein the AI request message comprises data to be processed, and the method further comprises:
storing the data to be processed in a user data repository (UDR) or an unstructured data storage network function (UDSF) in the core network, wherein the AI processing task comprises storage location information of the data to be processed.

9. The method according to claim 7, wherein the sending comprises:
transmitting the AI processing result to the destination end transparently via the core network according to the task processing result.

10. The method according to claim 1, wherein:
the destination end is the network element in the core network; and
the determining an artificial intelligence (AI) processing task, comprises:
collecting data from a preset network element in the core network; and
determining the AI processing task according to the collected data.

11. The method according to claim 10, wherein the sending comprises:
determining a target network element which requires service adjustment in the core network according to the task processing result; and
sending the AI service result to the target network element serving as the destination end in the core network.

12. (canceled)

13. An apparatus for artificial intelligence (AI) management, comprising:
a communication interface that is communicatively coupled to a core network;
a memory configured to store instructions; and
one or more processors that are communicatively coupled to the memory and the communication interface, wherein the one or more processors are collectively configured to;
determine an AI processing task via the core network;
determine a target service apparatus from a plurality of AI service apparatuses, wherein each of the plurality of the AI service apparatuses, utilize a different AI algorithm;
allocate the AI processing task to the target service apparatus;
obtain a task processing result of the target service apparatus; and
send an AI service result to a destination end according to the task processing result, wherein the destination end comprising a network element in the core network or a terminal accessing the core network.

14. A non-transitory computer-readable storage medium, storing a computer program instruction for improving a data transmission rate in a mobile communication network wherein, the computer program instruction, when executed by a processor, cause the processor to execute a method comprising:
determining an artificial intelligence (AI) processing task via a core network;
determining a target service apparatus from a plurality of AI service apparatuses, wherein each of the plurality of the AI service apparatuses, utilize a different AI algorithm;
allocating the AI processing task to the target service apparatus;
obtaining a task processing result of the target service apparatus; and
sending an AI service result to a destination end according to the task processing result, wherein the destination end comprising a network element in the core network or a terminal accessing the core network.

15. The apparatus according to claim 13, wherein the one or more processors are further collectively configured to:
determine an AI algorithm type of at least one AI service apparatus; and
determine a respective target service apparatus of which a respective AI algorithm type matches a task type of the AI processing task from the plurality of AI service apparatuses.

16. The apparatus according to claim 13, wherein when a multiple number of the target service apparatus are determined, and the one or more processors are further collectively configured to:
aggregate the task processing result of each respective target service apparatuses to obtain the AI service result, and
send the AI service result to the destination end.

17. The apparatus according to claim 13, wherein the one or more processors are further collectively configured to:
segment the AI processing task into a plurality of AI subtasks; and
determine a respective target service apparatus corresponding to at least one AI subtask from the plurality of AI service apparatuses, and
allocate the at least one AI subtask to the corresponding target service apparatus.

18. The apparatus according to claim 13, wherein the one or more processors are further collectively configured to:
determine computing power resources required for the AI processing task performed by the target service apparatus, and allocating the computing power resources to the target service apparatus.

19. The apparatus according to claim 13, wherein the AI processing task comprises data to be processed or storage location information of the data to be processed, and the data to be processed is used for the target service apparatus to perform the AI processing task.

20. The apparatus according to claim 13, wherein:
the destination end is the terminal accessing the core network; and
the one or more processors are further collectively configured to:
determine the AI processing task in response to an AI request message sent by the destination end via the core network.

21. The apparatus according to claim 13, wherein:
the destination end is the network element in the core network; and
the one or more processors are further collectively configured to:
collect data from a preset network element in the core network; and
determine the AI processing task according to the data collected.
